(19) United States
(12) Patent Application Publication
(10) Pub. No.: US 2017/0302337 A1
(43) Pub. Date: Oct. 19, 2017

(54) SIGNAL TRANSMISSION METHOD AND DEVICE

(71) Applicant: Huawei Technologies Co., Ltd., Shenzhen (CN)

(72) Inventors: Jinnan Liu, Beijing (CN); Xingwei Zhang, Beijing (CN)

(21) Appl. No.: 15/637,304

(22) Filed: Jun. 29, 2017

Related U.S. Application Data
(63) Continuation of application No. PCT/CN2014/095666, filed on Dec. 30, 2014.

(51) Int. Cl. H04B 7/005; H04W 52/14; H04B 7/26; H04N 1/00; H04B 7/00; G06F 13/00

(52) U.S. Cl. CPC H04B 7/005; H04W 52/146; H04B 7/26; H04B 7/00; G06F 13/00; H04N 2201/3335; H04N 1/00

(57) ABSTRACT

Embodiments of the present invention provide a signal transmission method and device. The method includes determining, by a first device, uplink transmit power and sending, by the first device on a first time-frequency resource by using the uplink transmit power, an uplink signal to a second device that operates in a full-duplex mode, where the uplink transmit power is power determined according to a self-interference compensation amount of the second device, or the uplink transmit power is maximum transmit power of the first device.

### CROSS-REFERENCE TO RELATED APPLICATIONS

This application is a continuation of International Application No. PCT/CN2014/095666, filed on Dec. 30, 2014, the disclosure of which is hereby incorporated by reference in its entirety.

### TECHNICAL FIELD

The present invention relates to the communications field, and in particular, to a signal transmission method and device.

### BACKGROUND

Currently, a frequency division duplex (FDD) mode and a time division duplex (TDD) mode are used in a cellular communications system. In FDD, receiving and sending are performed on one pair of separate channels, and an uplink (sending by a terminal and receiving by a base station) channel and a downlink (sending by a base station and receiving by a terminal) channel are separated by using a guard band. In TDD, uplink transmission and downlink transmission are performed in different subframes on a same frequency resource by using different uplink-downlink configurations. Currently, a wireless spectrum is under an increasing strain and services are flexible and diverse. Disadvantages of FDD and TDD are increasingly obvious. In FDD, paired spectrums are required, and uplink resources are the same as downlink resources in quantity. Therefore, spectrum division is difficult, and for an asymmetric service, uplink resources may not be fully used. During TDD networking, intra-frequency networks need to use a same configuration to avoid uplink-downlink interference. Therefore, uplink and downlink resources cannot be configured according to only a cell service. To overcome the disadvantages of FDD and TDD, FDD and TDD continuously evolve. In one manner, flexible uplink-downlink configuration is performed on a TDD band, and a network throughput is improved by controlling inter-cell interference. In another method, some uplink resources on an FDD uplink band are allocated, to match more diverse service types.

In recent years, a single channel full duplex technology, also referred to as a co-frequency co-time transmit and receive (transmit and receive at the same time on the same frequency) technology or a full-duplex wireless technology is put forward by Stanford University, Rice University, and so on. Different from an existing FDD or TDD technology, the wireless full-duplex technology implements simultaneous data sending and data receiving on a same band. Because receiving and sending operations are simultaneously performed on a same radio channel, theoretically, spectrum efficiency in the wireless full-duplex technology is twice as much as that in the FDD or TDD technology. In another method, the disadvantages of FDD and TDD can be overcome if the full-duplex technology is introduced to a cellular network. This is of great significance.

However, because a radio signal is attenuated greatly on a radio channel, in comparison with a transmit signal of a full-duplex device, an uplink signal from a communications peer end is very weak when the signal arrives at a receiver (a full-duplex device). For example, a difference between signal transmit power and signal received power of a communications node in a mobile cellular communications system is up to 800 dB to 140 dB or even greater. Therefore, self-interference from a transmit signal to a received signal exists in the full-duplex device. In the prior art, methods are taken to eliminate the self-interference of the full-duplex device, but the self-interference of the full-duplex device cannot be fully eliminated in the prior art, and a self-interference residual still exists. When the full-duplex technology is introduced to the cellular network, a self-interference residual problem still exists in the existing FDD or TDD system, thereby greatly affecting an uplink signal received by a full-duplex device and decreasing a signal-to-noise ratio of the received uplink signal. Therefore, it is expected to provide a technology that can eliminate or reduce adverse impact caused by a self-interference residual on reception of an uplink signal in a full-duplex system.

### SUMMARY

Embodiments of the present invention provide a signal transmission method and device, so as to eliminate or reduce interference in a full-duplex system.

According to a first aspect, a signal transmission method is provided, including determining, by a first device, uplink transmit power. The method also includes sending, by the first device on a first time-frequency resource by using the uplink transmit power, an uplink signal to a second device that operates in a full-duplex mode, where the uplink transmit power is power determined according to a self-interference compensation amount of the second device, or the uplink transmit power is maximum transmit power of the first device.

According to a second aspect, a signal transmission method is provided, including generating, by a second device, power indication information, where the power indication information is used by a first device to determine, according to the power indication information, uplink transmit power for sending an uplink signal to the second device that operates in a full-duplex mode, and the uplink transmit power is power determined according to a self-interference compensation amount of the second device, or the uplink transmit power is maximum transmit power of the first device. The method also includes sending, by the second device, the power indication information to the first device and receiving, by the second device, an uplink signal sent by the first device on a first time-frequency resource by using the uplink transmit power.

According to a third aspect, a signal transmission device is provided, including: a determining unit, configured to determine uplink transmit power; and a first sending unit, configured to send, on a first time-frequency resource by using the uplink transmit power, an uplink signal to a second device that operates in a full-duplex mode, where the second device is a full-duplex device, and the uplink transmit power is power determined according to a self-interference compensation amount of the second device, or the uplink transmit power is maximum transmit power of the first device.

According to a fourth aspect, a signal transmission device is provided, including: a first generation unit, configured to generate power indication information, where the power indication information is used by a first device to determine, according to the power indication information, uplink transmit power for sending an uplink signal to the device that operates in a full-duplex mode, and the uplink transmit power is power determined according to a self-interference compensation amount of the second device, or the uplink transmit power is maximum transmit power of the first device; a first sending unit, configured to send the power indication information to the first device; and a receiving unit, configured to receive an uplink signal sent by the first device on a first time-frequency resource by using the uplink transmit power.

Based on the foregoing technical solutions, in the embodiments of the present invention, a first device sends, by using uplink transmit power, an uplink signal to a second device that operates in a full-duplex mode, and the uplink transmit power is power determined according to a self-interference compensation amount of the second device, or the uplink transmit power is maximum transmit power of the first device. In the embodiments of the present invention, adverse impact caused by a self-interference residual amount of the second device on reception of an uplink signal is reduced by using the self-interference compensation amount of the second device, or adverse impact caused by a self-interference residual amount of the second device on reception of an uplink signal is eliminated by sending the uplink signal by the first device by using the maximum transmit power. Therefore, in the embodiments of the present invention, the adverse impact caused by the self-interference residual amount of the second device on the reception of the uplink signal can be eliminated or reduced, and network performance can be enhanced.

### BRIEF DESCRIPTION OF THE DRAWINGS

To describe the technical solutions in the embodiments of the present invention more clearly, the following briefly describes the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a diagram of a deployment scenario of an applicable full-duplex system according to an embodiment of the present invention;

FIG. 2 is a diagram of a deployment scenario of an applicable full-duplex system according to another embodiment of the present invention;

FIG. 3 is a schematic flowchart of a signal transmission method according to an embodiment of the present invention;

FIG. 4 is a schematic flowchart of a signal transmission method according to another embodiment of the present invention;

FIG. 5 is a schematic block diagram of a signal transmission device according to an embodiment of the present invention;

FIG. 6 is a schematic block diagram of a signal transmission device according to another embodiment of the present invention;

FIG. 7 is a schematic block diagram of a signal transmission device according to another embodiment of the present invention; and

FIG. 8 is a schematic block diagram of a signal transmission device according to another embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present embodiments.

It should be understood that, the technical solutions in the embodiments of the present invention may be applied to various communications systems such as a Long Term Evolution (LTE) system, an LTE frequency division duplex (FDD) system, an LTE time division duplex (TDD) system, a Universal Mobile Telecommunications System (UMTS), a Wireless Fidelity (WI-FI) communications system, or a Worldwide Interoperability for Microwave Access (WiMAX) communications system.

The embodiments of the present invention may be used in radio networks with different standards. A radio access network may include different network elements in different systems. For example, the radio access network includes a base station, an access point (AP), and a relay. Specifically, for example, network elements in the radio access network in LTE and LTE-A include an eNB (eNodeB, evolved NodeB), and network elements in the radio access network in WCDMA include an RNC (radio network controller) and a NodeB. Similarly, another radio network such as WiMAX may use solutions similar to those in the embodiments of the present invention, and the only difference is that related modules in a base station system may be different. This is not limited in the embodiments of the present invention. However, for ease of description, the following embodiments are described by using an example in which base stations are an eNodeB and a NodeB.

It should further be understood that, in the embodiments of the present invention, user equipment (UE) includes but is not limited to a mobile station (MS), a mobile terminal, a mobile telephone, a handset, portable equipment, and the like. The user equipment may communicate with one or more core networks by using a radio access network (RAN). For example, the user equipment may be a mobile telephone (or referred to as a “cellular” telephone), or a computer with a wireless communication function; or the user equipment may be a portable, pocket-sized, handheld, computer built-in, or in-vehicle mobile apparatus.

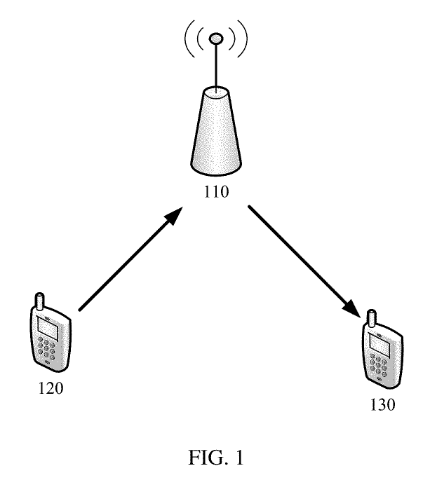

FIG. 1 is a diagram of a deployment scenario of an applicable full-duplex system according to an embodiment of the present invention. The scenario, shown in FIG. 1, of the full-duplex system includes a base station 110, user equipment 120, and user equipment 130.

The base station 110 has a full-duplex capability, and the user equipment 120 has a half-duplex capability. During co-frequency co-time sending and receiving, the base station 110 may schedule some terminals such as the user equipment 120 within coverage of the base station 110 to perform uplink transmission, and other terminals such as the user equipment 130 to perform downlink receiving.

It should be understood that, the base station 110 in FIG. 1 may be substituted with a small cell, an access point, or the like. This is not limited in this embodiment of the present invention.

It should be noted that, only one base station (an isolated base station) is shown in the scenario shown in FIG. 1, but this embodiment of the present invention is not limited thereto. There may be a neighboring base station and user equipment (not shown in the figure) that transmit a service on a time-frequency resource shared by the base station 110.

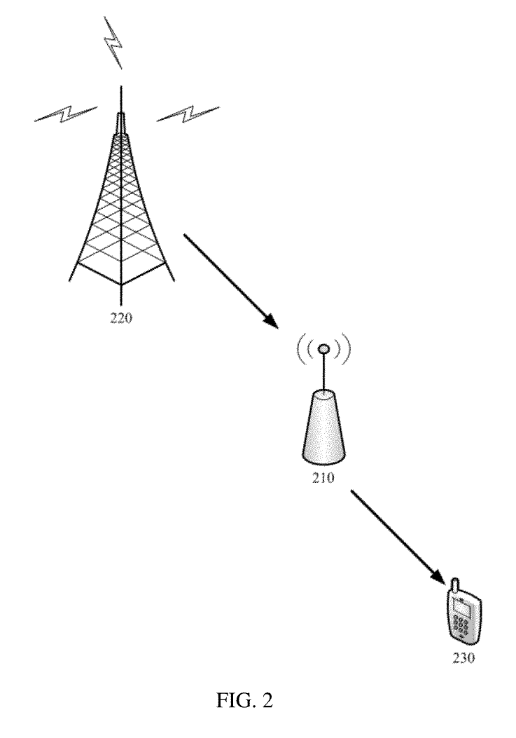

FIG. 2 is a diagram of a deployment scenario of an applicable full-duplex system according to another embodiment of the present invention. The scenario, shown in FIG. 2, of the full-duplex system includes a relay 210, a base station 220, and user equipment 230. The relay 210 has a full-duplex capability. When the relay 210 performs full-duplex transmission, the relay 210 receives a signal from the base station 220 and sends a downlink signal to the user equipment 230 by using a same time-frequency resource, or the relay 210 receives a signal from the user equipment 230 and sends a downlink signal to the base station 220 by using a same time-frequency resource.

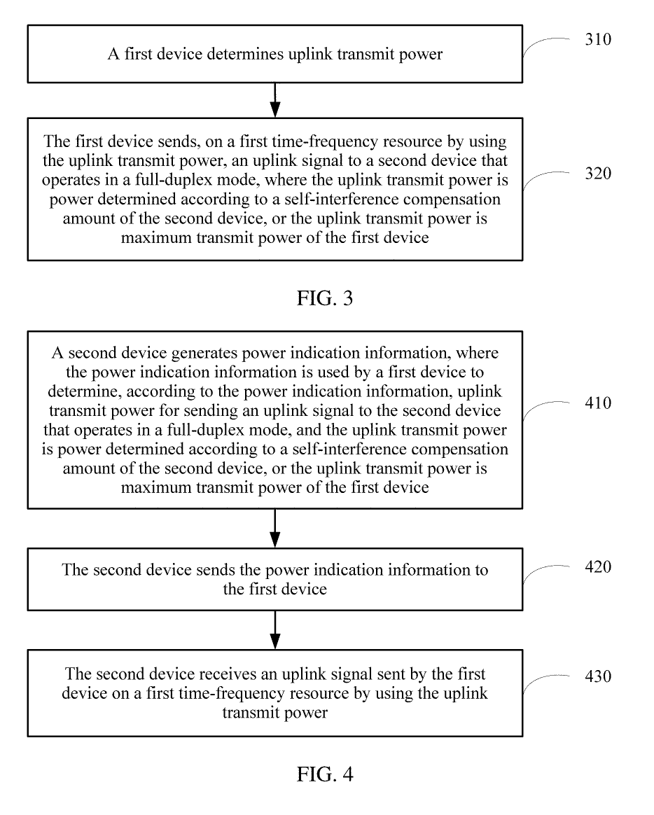

FIG. 3 is a schematic flowchart of a signal transmission method according to an embodiment of the present invention. The method in FIG. 3 is executed by a first device. If the method is applied to the scenario in FIG. 1, the first device may be user equipment. If the method is applied to the scenario in FIG. 2, the first device may be a base station or user equipment. Specifically, the method shown in FIG. 3 includes the following steps:

310. The first device determines uplink transmit power.

In other words, the first device determines the uplink transmit power for sending an uplink signal to a second device.

The first device sends, on a first time-frequency resource by using the uplink transmit power, an uplink signal to a second device that operates in a full-duplex mode, where the uplink transmit power is power determined according to a self-interference compensation amount of the second device, or the uplink transmit power is maximum transmit power of the first device.

Specifically, the second device is a full-duplex device that is capable of simultaneously sending and receiving signals at a same frequency. For example, the second device may be a base station or a relay.

It should be understood that, the first time-frequency resource may be a full-duplex time-frequency resource, and the full-duplex time-frequency resource indicates that both an uplink service and a downlink service are carried on the resource. The second device may also send a downlink signal to another device on the full-duplex time-frequency resource. That is, on the full-duplex time-frequency resource, the second device not only may receive an uplink signal sent by the first device, but may also send a signal to another device.

It should be noted that, the full-duplex device refers to a device that is capable of simultaneously sending and receiving signals at a same frequency. The full-duplex device may have multiple operating modes such as a full-duplex mode and a half-duplex mode. The full-duplex device may operate in a full-duplex mode or return to (be switched to) a half-duplex mode. It may be determined, according to an interference status, a service status, a user distribution status, and the like in a system, whether the full-duplex device operates in a full-duplex mode or a half-duplex mode.

When the full-duplex device operates in a full-duplex mode, the full-duplex device may be in two states. One state is full-duplex communication, and a corresponding resource is a full-duplex time-frequency resource, that is, the full-duplex device not only sends data but also receives data on the full-duplex time-frequency resource. The other state is full-duplex monitoring, and a corresponding resource is a half-duplex downlink resource, that is, the full-duplex device sends data on the half-duplex downlink resource. A receiving link is used only for interference monitoring or interference measurement, but is not used to demodulate received data. When the full-duplex device operates in a half-duplex mode, a corresponding resource is a half-duplex time-frequency resource, and the full-duplex device either sends a signal or receives a signal on the half-duplex time-frequency resource.

It should be noted that, a time-frequency resource may generally refer to a communications resource. For example, the time-frequency resource may refer to a communications resource in a time dimension and a frequency dimension. A minimum unit of the time-frequency resource is not limited in this embodiment of the present invention. For example, the minimum unit of the time-frequency resource may be a subframe, a frame, or a timeslot in terms of time, and may be a resource block (RB), a subcarrier, a resource element (RE), a sub-band, or an entire operating band in terms of frequency.

Specifically, the first device sends a signal to the second device by using the uplink transmit power, and the uplink transmit power may be power determined according to the self-interference compensation amount of the second device and an uplink open-loop power parameter of the first device. The uplink open-loop power parameter of the first device may be open-loop power of a physical uplink control channel (PUCCH) or open-loop power of a physical uplink shared channel (PUSCH). It should be understood that, the uplink transmit power may be power determined by the second device according to the uplink open-loop power parameter of the first device and the self-interference compensation amount of the second device, or may be power determined by the first device according to the uplink open-loop power parameter of the first device and the self-interference compensation amount of the second device; or the uplink transmit power is the maximum transmit power of the first device.

In conclusion, in this embodiment of the present invention, a first device sends, by using uplink transmit power, an uplink signal to a second device that operates in a full-duplex mode, and the uplink transmit power is power determined according to a self-interference compensation amount of the second device, or the uplink transmit power is maximum transmit power of the first device. In this embodiment of the present invention, adverse impact caused by a self-interference residual amount of the second device on reception of an uplink signal is reduced by using the self-interference compensation amount of the second device, or adverse impact caused by a self-interference residual amount of the second device on reception of an uplink signal is eliminated by sending the uplink signal by the first device by using the maximum transmit power. Therefore, in this embodiment of the present invention, the adverse impact caused by the self-interference residual amount of the second device on the reception of the uplink signal can be eliminated or reduced, a signal-to-noise ratio of the received uplink signal can be increased, and network performance can be enhanced.

Optionally, in another embodiment, in step 310, the first device obtains power indication information sent by the second device, and the power indication information is used to indicate a self-interference compensation amount of the second device; and the first device determines the uplink transmit power according to the self-interference compensation amount and an uplink open-loop power parameter.

Specifically, the self-interference compensation amount is determined by the second device according to the following formula:

Δ_{SI}=10*log₁₀(N+1) dB,

where Δ_{SI} indicates the self-interference compensation amount, N indicates that self-interference residual power is N multiples of noise power, and N>0.

When the second device is a base station, the base station may schedule all subframes (time-frequency resources) for full-duplex transmission. Therefore, in each uplink subframe, the first device needs to add a self-interference compensation amount to an open-loop parameter, to adjust uplink transmit power of the first device. Specifically, the first device adds the self-interference compensation amount to an open-loop power parameter that affects each channel, such as open-loop power of a PUCCH channel in LTE or open-loop power of a PUSCH in LTE. That is, the uplink transmit power of the first device is power determined according to a sum of the uplink open-loop power parameter of the first device and the self-interference compensation amount of the second device.

Alternatively, when the second device is a relay, the relay may schedule all subframes (time-frequency resources) for full-duplex transmission. In one case, the first device is user equipment, and the relay sends a downlink signal to a base station and receives an uplink signal from a terminal. In this case, the terminal adds a self-interference compensation amount to an open-loop parameter or a close-loop parameter, to adjust uplink transmit power of the user equipment. Specifically, the first device adds the self-interference compensation amount to an open-loop power parameter that affects each channel, such as open-loop power of a PUCCH channel in LTE or open-loop power of a PUSCH in LTE. That is, the uplink transmit power of the first device is a sum of the uplink open-loop power parameter of the first device and the self-interference compensation amount of the second device. In another case, the first device is a base station, and the relay sends a downlink signal to user equipment and receives an uplink signal from the base station. Similarly, the base station adds a self-interference residual compensation amount of the relay to an open-loop parameter or a close-loop parameter, to adjust uplink transmit power of the base station. Specifically, the base station adds a self-interference residual offset to an open-loop parameter or a close-loop parameter such as open-loop power of a PUCCH channel or open-loop power of a PUSCH. That is, the uplink transmit power of the first device is power determined according to a sum of the uplink open-loop power parameter of the first device and the self-interference compensation amount of the second device.

For example, uplink power control in LTE is a manner in which open-loop power control is combined with close-loop correction.

For example, power of a PUSCH in a subframe i is defined as:

$${P}_{PUSCH , c} ( i ) = min \{ \begin{matrix}{P}_{CMAX , c} ( i ) , \\ 10 {log}_{10} ( {M}_{PUSCH , c} ( i ) ) + {P}_{O \_ PUSCH , c} ( j ) + {α}_{c} ( j ) \cdot {PL}_{c} + {Δ}_{TF , c} ( i ) + {f}_{c} ( i ) \end{matrix} \} [ dBm ] ,$$

where P_{CMAX,c}(i) indicates maximum transmit power of a terminal, P_{PUSCH,c}(i) indicates an RB quantity allocated based on an uplink grant, P_{O}_{_}_{PUSCH,c}(j) indicates an open-loop power parameter, α_{c}(j) indicates a path loss factor, PL_{c} indicates a downlink path loss estimation amount, Δ_{TF,c}(i) indicates a transmission manner compensation amount, and f_{c}(i) indicates a dynamic power control offset.

A value of j is 0, 1, or 2, where 0 indicates uplink transmission based on semi-persistent scheduling, 1 indicates uplink transmission based on dynamic scheduling, and 2 indicates uplink transmission based on random access.

P_{O}_{_}_{PUSCH,c}(0)=P_{O}_{_}_{NOMINAL}_{_}_{PUSCH,c}(0)+P_{O} _{_}_{UE}_{_}_{PUSCH,c}(0)

P_{O}_{_}_{PUSCH,c}(1)=P_{O}_{_}_{NOMINAL}_{_}_{PUSCH,c}(1)+P_{O} _{_}_{UE}_{_}_{PUSCH,c}(1)

P_{O}_{_}_{NOMINAL}_{_}_{PUSCH,c}(2)=P_{O}_{_}_{PRE}+Δ_{PREAMBLE}_{_}_{Msg3}

P_{O}_{_}_{NOMINAL}_{_}_{PUSCH,c}(j)

is a cell-specific parameter that is indicated by using higher layer signaling and that is broadcasted to a terminal, P_{O}_{_}_{UE}_{_}_{PUSCH,c}(j) is a UE-specific component that is configured by using radio resource control (RRC) signaling, and P_{O}_{_}_{PRE} and Δ_{PREAMBLE}_{_}_{Msg3} are higher layer parameters for random access.

When uplink signals are simultaneously transmitted on a PUSCH and a PUCCH,

$${P}_{PUSCH , c} ( i ) = min \{ \begin{matrix}10 {log}_{10} ( {\hat{P}}_{CMAX , c} ( i ) - {\hat{P}}_{PUCCH} ( i ) ) , \\ 10 {log}_{10} ( {M}_{PUSCH , c} ( i ) ) + {P}_{O \_ PUSCH , c} ( j ) + {α}_{c} ( j ) \cdot {PL}_{c} + {Δ}_{TF , c} ( i ) + {f}_{c} ( i ) \end{matrix} \} [ dBm ] ,$$

where \hat{P}_{PUCCH}(i) is power of the PUCCH in the subframe i. P_{O}_{_}_{PUSCH,c}(j) is affected by a self-interference residual amount, thereby affecting P_{PUSCH,c}(i).

After a self-interference compensation amount Δ_{SI}(j) of a base station is considered, a transmit power formula is modified to:

$${P}_{PUSCH , c} ( i ) = min \{ \begin{matrix}{P}_{CMAX , c} ( i ) , \\ 10 {log}_{10} ( {M}_{PUSCH , c} ( i ) ) + {P}_{O \_ PUSCH , c} ( j ) + {Δ}_{SI} ( j ) + {α}_{c} ( j ) \cdot {PL}_{c} + {Δ}_{TF , c} ( i ) + {f}_{c} ( i ) \end{matrix} \} [ dBm ] , \\ or \\ {P}_{PUSCH , c} ( i ) = min \{ \begin{matrix}10 {log}_{10} ( {\hat{P}}_{CMAX , c} ( i ) - {\hat{P}}_{PUCCH} ( i ) ) , \\ 10 {log}_{10} ( {M}_{PUSCH , c} ( i ) ) + {P}_{O \_ PUSCH , c} ( j ) + {Δ}_{SI} ( j ) + {α}_{c} ( j ) \cdot {PL}_{c} + {Δ}_{TF , c} ( i ) + {f}_{c} ( i ) \end{matrix} \} [ dBm ] .$$

Higher layer signaling P_{O}_{_}_{NOMINAL}_{_}_{PUSCH,c}(j) is broadcasted to the terminal by using higher layer signaling, and P_{O}_{_}_{UE}_{_}_{PUSCH,c}(j) is configured for the terminal by using RRC signaling. Therefore, the terminal may be notified of Δ_{SI}(j) by using signaling carrying P_{O}_{_}_{NOMINAL}_{_}_{PUSCH,c}(j) or P_{O}_{_}_{UE}_{_}_{PUSCH,c}(j), or new configured signaling, so as to compensate an open-loop power parameter.

Similarly, on a PUCCH channel, power of the PUCCH in the subframe i is defined as:

$${P}_{PUCCH} ( i ) = min \{ \begin{matrix}{P}_{CMAX , c} ( i ) , \\ {P}_{0 \_ PUCCH} + {PL}_{c} + h ( {n}_{CQI} , {n}_{HARQ} , {n}_{SR} ) + {Δ}_{F \_ PUCCH} ( F ) + {Δ}_{Txd} ( {F}^{′} ) + g ( i ) \end{matrix} \} [ dBm ] ,$$

where h(n_{CQI},n_{HARQ},n_{SR}) is a parameter of a PUCCH format and is used for transmitting a CQI (channel quality indicator), an HARQ (hybrid automatic repeat request) feedback, and an SR (scheduling request).

P_{O}_{_}_{PUCCH}=P_{O}_{_}_{NOMINAL}_{_}_{PUCCH}+P_{O}_{_}_{UE}_{_}_{PUCCH}.

An open-loop power parameter P_{O}_{_}_{PUCCH} is affected by self-interference, thereby affecting P_{PUCCH}(i). After a self-interference compensation amount Δ_{SI} is considered,

$${P}_{PUCCH} ( i ) = min \{ \begin{matrix}{P}_{CMAX , c} ( i ) , \\ {P}_{0 \_ PUCCH} + {Δ}_{SI} + {PL}_{c} + h ( {n}_{CQI} , {n}_{HARQ} , {n}_{SR} ) + {Δ}_{F \_ PUCCH} ( F ) + {Δ}_{Txd} ( {F}^{′} ) + g ( i ) \end{matrix} \} [ dBm ] .$$

Similarly, P_{O}_{_}_{PUCCH} may be carried by using multiple types of signaling. Therefore, the terminal may be notified of Δ_{SI} by using signaling carrying P_{O}_{_}_{NOMINAL}_{_}_{PUCCH} or P_{O}_{_}_{UE}_{_}_{PUCCH}, or new configured signaling, so as to compensate an open-loop power parameter.

In addition, when a neighboring base station of a full-duplex base station is also in a full-duplex mode, even if there is no self-interference, inter-base station interference to the base station is greater than that to the base station in a half-duplex mode. Therefore, open-loop power parameters are different in two cases and are respectively used for a half-duplex uplink subframe and an uplink subframe in which the base station operates in a full-duplex mode. The base station needs to notify a terminal of two open-loop power parameters, and the terminal compensates a self-interference compensation amount to an open-loop power parameter of the uplink subframe in which the base station operates in a full-duplex mode.

Further, in another embodiment, the uplink open-loop power parameter includes a first uplink open-loop power parameter or a second uplink open-loop power parameter. In step 310, the first device determines the uplink transmit power according to the self-interference compensation amount and the first uplink open-loop power parameter; or in step 310, the first device determines the uplink transmit power according to the self-interference compensation amount and the second uplink open-loop power parameter.

In other words, the second device may configure two uplink open-loop power parameters for the first device, and the two uplink open-loop power parameters are the first uplink open-loop power parameter and the second uplink open-loop power parameter respectively. On different time-frequency resources, a base station may determine uplink transmit power according to different uplink open-loop power parameters and a self-interference compensation amount.

Alternatively, in another embodiment, in step 310, the first device obtains power indication information sent by the second device, and the power indication information is used to indicate the uplink transmit power.

In other words, the second device directly determines the uplink transmit power of the first device and sends the uplink transmit power to the first device by using the power indication information. The first device directly uses the uplink transmit power to send an uplink signal, without performing other calculation.

Specifically, power for sending an uplink signal on a full-duplex time-frequency resource is power determined by the second device according to the self-interference compensation amount of the second device. The uplink transmit power is power determined according to the sum of the uplink open-loop power parameter of the first device and the self-interference compensation amount of the second device.

Optionally, in another embodiment, the method in this embodiment of the present invention further includes: obtaining, by the first device, information that is used for indicating second power and that is sent by the second device; and sending, by the first device on a second time-frequency resource by using the second power, an uplink signal to the second device that operates in a half-duplex mode.

The second time-frequency resource may be a half-duplex time-frequency resource. It should be noted that, when a full-duplex time-frequency resource is divided in a unit of subframe, the full-duplex time-frequency resource is equivalent to (the same as) a full-duplex subframe, and the full-duplex time-frequency resource may be substituted with the full-duplex subframe.

It should be understood that, the half-duplex time-frequency resource indicates that on this resource, the second device can carry either an uplink service or a downlink service. Different from the half-duplex time-frequency resource, on the full-duplex time-frequency resource, the second device can carry both an uplink service and a downlink service.

Specifically, power for sending an uplink signal by the first device on a half-duplex time-frequency resource may be second power directly determined by the second device without considering the self-interference compensation amount of the second device. Then the second device notifies the first device that second uplink transmit power may be power determined according to the uplink open-loop power parameter of the first device.

In other words, there are two cases. In one case, the first device sends an uplink signal on the first time-frequency resource. In the other case, the first device sends an uplink signal on the second time-frequency resource. Two different power adjustment parameters are corresponding to the two cases. The first time-frequency resource may be a full-duplex time-frequency resource, and the second time-frequency resource may be a half-duplex time-frequency resource.

Specifically, when the second device is a base station, the base station may schedule some subframes for full-duplex transmission and reserve some subframe resources for half-duplex uplink transmission. Interference to the half-duplex uplink transmission is different from interference to uplink transmission in the full-duplex transmission. Therefore, two different power adjustment parameters are required for respectively performing power control in the half-duplex uplink transmission and power control in the uplink transmission in the full-duplex transmission.

The first device sends an uplink signal to the second device on a full-duplex time-frequency resource by using the uplink transmit power, and the first device sends an uplink signal to the second device on a half-duplex time-frequency resource by using the second power.

Interference in a full-duplex subframe is completely different from interference in a half-duplex subframe, and not only interference of a self-interference residual amount but also downlink interference from a neighboring station exist in a full-duplex uplink subframe. Therefore, common power control parameters cannot be shared, and a self-interference residual offset is considered for a power control parameter on a full-duplex time-frequency resource.

Alternatively, when the second device is a relay, in one possible case, the relay sends data to a base station and receives data from a terminal. On subframe resources used for transmitting uplink data by the terminal, if the relay is in a full-duplex state in some subframes and is in a half-duplex state in some other subframes (the relay receives an uplink signal from the terminal), because interference to half-duplex uplink transmission is different from interference to uplink transmission in full-duplex transmission, the relay may use two different power adjustment parameters to respectively perform power control in the half-duplex uplink transmission and power control in the uplink transmission in the full-duplex transmission. That is, the first device sends an uplink signal to the second device on a full-duplex time-frequency resource by using the uplink transmit power, and the first device sends another uplink signal to the second device on a half-duplex time-frequency resource by using the second power. In another possible case, similar to the foregoing case, the relay sends data to user equipment and receives data from a base station. To avoid repetition, details are not repeatedly described.

Optionally, in another embodiment, the first time-frequency resource is used by a third device to receive a downlink signal sent by the second device, the first device and the third device are a pair of devices whose inter-device interference is less than a preset threshold, and the second device predetermines that interference between the first device and the third device is less than the preset threshold.

In other words, the first device is a first terminal in a first terminal pair, and the first terminal pair includes the first terminal and a second terminal. The first terminal pair is a terminal pair whose inter-terminal interference is less than the preset threshold and that is in all terminal pairs including a first terminal group and a second terminal group. The second terminal receives, on a full-duplex time-frequency resource on which the first terminal sends an uplink signal to the second device, a downlink signal sent by the second device.

Specifically, before the first device sends the uplink signal on the full-duplex time-frequency resource, a terminal sends an uplink control signal, an uplink data signal, or an uplink sounding signal in a half-duplex uplink transmission subframe. The uplink control signal, the uplink data signal, and the uplink sounding signal are respectively corresponding to a PUCCH, a PUSCH, and a sounding reference signal (SRS) in an LTE system. A base station uses a resource of this type, such as a full-duplex time-frequency resource, to schedule some terminals in the first terminal group including the first device to transmit an uplink sounding signal, and to schedule some terminals in the second terminal group including the third device to receive an uplink sounding signal. It should be noted that, if different modulation schemes are used in an uplink and a downlink, a terminal in the second terminal group needs to be capable of performing sending and receiving in two different modulation schemes. For example, in LTE, a single carrier frequency division multiple access (SC-FDMA) modulation scheme is used in an uplink, and an orthogonal frequency division multiplexing (OFDM) modulation scheme is used in a downlink. The terminal in the second terminal group needs to be capable of performing SC-FDMA demodulation. Terminals (some terminals in the second terminal group) in a receiving state measure interference between other terminals within coverage of the second device. Therefore, some terminals are arranged to perform measurements on uplink resources, and to assist the terminals in interference measurements, the base station adds, to an uplink sounding signal, information for sending an SRS, and the second device reserves a resource for measuring and reporting inter-user interference information. When scheduling a full-duplex subframe, the base station selects a pair of devices (the first device and the third device) whose interference is less than the preset threshold, to separately send an uplink signal and receive a downlink signal on a same time-frequency resource.

Optionally, in another embodiment, the method is applied to a downlink band in an FDD system. The interference between the first device and the third device is measured by using a half-duplex uplink time-frequency resource that is set by the second device on the downlink band.

Specifically, to measure a self-interference residual amount, a base station or a relay needs to divide some resources on an uplink band as half-duplex downlink resources for measuring the self-interference residual amount, and notifies a terminal, or the base station and a terminal of the self-interference residual amount. Similar to a design in TDD, a downlink resource of this type, such as a half-duplex downlink resource, is not essential for each subframe. To reduce handovers performed by the terminal, or the base station and the terminal on different bands, a downlink time division resource or a downlink frequency division resource on the uplink band is used for a self-interference measurement and used as a resource for notifying a self-interference compensation amount parameter.

Optionally, in another embodiment, the method in this embodiment of the present invention further includes: receiving, by the first device, a first downlink signal sent by the second device on a full-duplex time-frequency resource according to a first transmission parameter, where the first transmission parameter makes interference between the second device and a neighboring station of the second device less than a preset interference threshold; and receiving, by the first device, a second downlink signal sent by the second device on a half-duplex time-frequency resource according to a second transmission parameter.

Specifically, the second device may be a base station. The second device sends downlink signals by using two transmission parameters including the first transmission parameter and the second transmission parameter. The first transmission parameter may be used as a transmission parameter for a full-duplex subframe in which a full-duplex device (the second device) operates. The second transmission parameter is used as a transmission parameter for a half-duplex subframe in which a full-duplex device operates.

It should be understood that, transmission parameters may include parameters such as transmit power, an antenna downtilt angle, a propagation model, an antenna height of a base station.

If all subframes are used for full-duplex transmission, downlink coverage of the base station (the second device) cannot be ensured. Therefore, to ensure coverage of the base station, the base station may need to reserve some subframes for half-duplex downlink transmission. In addition, if a same transmission parameter is used by the base station in a half-duplex downlink and in a downlink of a full-duplex subframe, strong interference is caused to uplink receiving by a neighboring base station. Therefore, a downlink parameter used by the base station in the downlink of the full-duplex subframe needs to be different from that used in a half-duplex downlink subframe.

The base station needs to calculate in advance maximum values of transmit power and a downtilt angle by using parameters such as an inter-cell distance, a propagation model, an antenna height of a base station, so as to reduce inter-base station interference to reception of uplink data. In a full-duplex subframe transmission process, the transmit power and the downtilt angle cannot exceed the foregoing maximum values.

It should be understood that, in the foregoing embodiments, for example, the first device may send an uplink signal on a full-duplex time-frequency resource or a half-duplex time-frequency resource, and the first device may further receive a downlink signal from the second device on another full-duplex time-frequency resource or another half-duplex time-frequency resource. It should be noted that, the first device may send an uplink signal on a full-duplex time-frequency resource or a half-duplex time-frequency resource, but a device that receives a downlink signal from the second device on another full-duplex time-frequency resource or another half-duplex time-frequency resource may be another device instead of the first device. This is not limited in this embodiment of the present invention.

Further, in another embodiment, the method in this embodiment of the present invention may further include: if the first downlink signal is a cell-specific reference signal (CRS) sent by using a first transmission parameter, performing, by the first device, CRS-related measurement between the first device and the second device according to the CRS sent by using the first transmission parameter; or if the second downlink signal is a CRS sent by using a second transmission parameter, performing, by the first device, CRS-related measurement between the first device and the second device according to the CRS sent by using the second transmission parameter.

In other words, the first device performs CRS-related measurement between the first device and the second device according to a received cell-specific reference signal CRS sent by the second device by using the first transmission parameter; or the first device performs CRS-related measurement between the first device and the second device according to a received CRS sent by the second device by using the second transmission parameter.

Specifically, in a half-duplex downlink subframe and a full-duplex subframe, the second device sends downlink signals by using different downlink parameters. Therefore, a measurement related to a CRS (cell-specific reference signal) in the half-duplex downlink subframe cannot be performed or smoothed in the full-duplex subframe. For example, the measurement may include a path loss measurement, reference signal received power (RSRP) measurement, and reference signal received quality (RSRQ) measurement.

For example, in a half-duplex system, a terminal performs a path loss measurement by using a CRS sent by a base station, and transmit power of the CRS is notified to the terminal by using higher layer signaling. The terminal calculates a path loss according to a difference between received CRS power and the power notified by the base station to the terminal. However, when the base station is on a full-duplex time-frequency resource, there may be no CRS, or there is a CRS, but power used for the CRS is different from power used on a half-duplex time-frequency resource. If measurement results in subframes of two types are smoothed between subframes, an estimation error occurs. A CRS case is similar to an RSRP case and an RSRQ case. Therefore, in this embodiment of the present invention, for CRS-related measurements on two different time-frequency resources (a full-duplex time-frequency resource and a half-duplex time-frequency resource), smoothing between subframe sets is not performed.

It should be understood that, in the foregoing embodiments, for example, the first device may send an uplink signal on a full-duplex time-frequency resource or a half-duplex time-frequency resource, and the first device may further receive a downlink signal from the second device on another full-duplex time-frequency resource or another half-duplex time-frequency resource. It should be noted that, the first device may send an uplink signal on a full-duplex time-frequency resource or a half-duplex time-frequency resource, but a device that receives a downlink signal from the second device on another full-duplex time-frequency resource or another half-duplex time-frequency resource may be another device that is scheduled by a base station for downlink receiving, instead of the first device. This is not limited in this embodiment of the present invention. Therefore, when the first device receives the downlink signal, the first device may perform CRS-related measurement between the first device and the second device. When the another device receives the downlink signal from the second device, the another device performs CRS-related measurement.

Optionally, in another embodiment, the first device is a device in a fourth device, and the fourth device includes at least one device. A signal to interference plus noise ratio (SINR) of the fourth device is greater than a preset threshold.

Specifically, when scheduling a full-duplex subframe, the second device schedules a device whose SINR is greater than the preset threshold to receive a downlink signal. The SINR may be reflected by using a channel quality indicator (CQI) reported by a terminal.

In a half-duplex communications system, a base station adjusts an MCS (Modulation and coding scheme) level of a terminal by using a channel quality indicator (CQI) fed back by the terminal. If the base station operates in a full-duplex mode, some half-duplex terminals are separately in a receiving state or a sending state. Therefore, a downlink receiving status deteriorates due to inter-terminal interference. If a terminal with a lower SINR is scheduled, the SINR further deteriorates when the terminal is interfered by a terminal that performs uplink transmission, so that the terminal cannot demodulate downlink data. Therefore, inter-user interference can be eliminated if an user with higher SINR or an user with reduced modulation and coding level (MCS) is selected.

In addition, when scheduling a full-duplex subframe, the second device may schedule a device whose transmit power headroom (PH) is greater than a preset headroom threshold to send an uplink signal. Specifically, in the half-duplex communications system, a base station learns a PH of a terminal by using an uplink power headroom report (PHR) fed back by the terminal. When a PH is high, it indicates that the terminal may send an uplink signal by using greater transmit power, so as to compensate self-interference impact.

It should be understood that, in an example of this embodiment, when scheduling a full-duplex subframe, the second device may schedule a device whose SINR is greater than a preset threshold or whose channel quality indicator (CQI) is greater than a preset channel quality threshold to receive a downlink signal. When scheduling the full-duplex subframe, the second device may schedule a device whose PH is greater than the preset threshold to send an uplink signal.

With reference to FIG. 3, the signal transmission method in this embodiment of the present invention is described above in detail from a perspective of the first device. With reference to FIG. 4, a signal transmission method in an embodiment of the present invention is described below from a perspective of a second device.

FIG. 4 is a schematic flowchart of a signal transmission method according to another embodiment of the present invention. The method in FIG. 4 is executed by a second device. If the method is applied to the scenario in FIG. 1, the second device may be a base station, and a first device may be user equipment. If the method is applied to the scenario in FIG. 2, the second device may be a relay, and a first device may be a base station or user equipment.

It should be understood that, a difference between FIG. 4 and FIG. 3 is that the signal transmission method in this embodiment of the present invention is described from a perspective of the second device in FIG. 4 while the signal transmission method in the embodiment of the present invention is described from a perspective of the first device in FIG. 3. The signal transmission method in FIG. 4 is corresponding to the signal transmission method in FIG. 3. For description related to the signal transmission method in FIG. 4, refer to description of the method in FIG. 3. To avoid repetition, detailed description is properly omitted below.

Specifically, the method shown in FIG. 4 includes the following steps.

410. The second device generates power indication information, where the power indication information is used by the first device to determine, according to the power indication information, uplink transmit power for sending an uplink signal to the second device that operates in a full-duplex mode, and the uplink transmit power is power determined according to a self-interference compensation amount of the second device, or the uplink transmit power is maximum transmit power of the first device.

420. The second device sends the power indication information to the first device.

430. The second device receives an uplink signal sent by the first device on a first time-frequency resource by using the uplink transmit power.

Specifically, the second device is a full-duplex device that is capable of simultaneously sending and receiving signals at a same frequency. For example, the second device may be a base station or a relay.

It should be understood that, the first time-frequency resource may be a full-duplex time-frequency resource, and the full-duplex time-frequency resource indicates that both an uplink service and a downlink service are carried on the resource. The second device may also send a downlink signal to another device on the full-duplex time-frequency resource. That is, on the full-duplex time-frequency resource, the second device not only may receive an uplink signal sent by the first device, but may also send a signal to another device.

It should be noted that, the full-duplex device refers to a device that is capable of simultaneously sending and receiving signals at a same frequency. The full-duplex device may have multiple operating modes such as a full-duplex mode and a half-duplex mode. The full-duplex device may operate in a full-duplex mode or return to (be switched to) a half-duplex mode. It may be determined, according to an interference status, a service status, a user distribution status, and the like in a system, whether the full-duplex device operates in a full-duplex mode or a half-duplex mode.

When the full-duplex device operates in a full-duplex mode, the full-duplex device may be in two states. One state is full-duplex communication, and a corresponding resource is a full-duplex time-frequency resource, that is, the full-duplex device not only sends data but also receives data on the full-duplex time-frequency resource. The other state is full-duplex monitoring, and a corresponding resource is a half-duplex downlink resource, that is, the full-duplex device sends data on the half-duplex downlink resource. A receiving link is used only for interference monitoring or interference measurement, but is not used to demodulate received data. When the full-duplex device operates in a half-duplex mode, a corresponding resource is a half-duplex time-frequency resource, and the full-duplex device either sends a signal or receives a signal on the half-duplex time-frequency resource.

It should be noted that, a time-frequency resource may generally refer to a communications resource. For example, the time-frequency resource may refer to a communications resource in a time dimension and a frequency dimension. A minimum unit of the time-frequency resource is not limited in this embodiment of the present invention. For example, the minimum unit of the time-frequency resource may be a subframe, a frame, or a timeslot in terms of time, and may be an RB, a subcarrier, an RE, a sub-band, or an entire operating band in terms of frequency.

Specifically, the first device sends a signal to the second device by using the uplink transmit power, and the uplink transmit power may be power determined according to the self-interference compensation amount of the second device and an uplink open-loop power parameter of the first device. The uplink open-loop power parameter of the first device may be open-loop power of a PUCCH or open-loop power of a PUSCH. It should be understood that, the uplink transmit power may be power determined by the second device according to a sum of the uplink open-loop power parameter of the first device and the self-interference compensation amount of the second device, or may be power determined by the first device according to a sum of the uplink open-loop power parameter of the first device and the self-interference compensation amount of the second device; or the uplink transmit power is the maximum transmit power of the first device.

In conclusion, in this embodiment of the present invention, a second device generates power indication information for indicating uplink transmit power, sends the power indication information to a first device, and receives an uplink signal sent by the first device on a first time-frequency resource by using the uplink transmit power. In this embodiment of the present invention, adverse impact caused by a self-interference residual amount of the second device on reception of an uplink signal is reduced by using a self-interference compensation amount of the second device, or adverse impact caused by a self-interference residual amount of the second device on reception of an uplink signal is eliminated by sending the uplink signal by the first device by using maximum transmit power. Therefore, in this embodiment of the present invention, the adverse impact caused by the self-interference residual amount of the second device on the reception of the uplink signal can be eliminated or reduced, a signal-to-noise ratio of the received uplink signal can be increased, and network performance can be enhanced.

Optionally, in another embodiment, before step 410, the method in this embodiment of the present invention further includes: determining, by the second device, the self-interference compensation amount of the second device.

In step 410, the second device generates the power indication information according to the self-interference compensation amount.

For example, the second device determines the self-interference compensation amount of the second device according to the following formula:

Δ_{SI}=10*log₁₀(N+1) dB,

where Δ_{SI} indicates the self-interference compensation amount, N indicates that self-interference residual power is N multiples of noise power, and N>0.

Specifically, the second device first determines the self-interference compensation amount of the second device, and generates the power indication information according to the self-interference compensation amount. The power indication information is used by the first device to determine, according to the power indication information, uplink transmit power for sending an uplink signal to the second device. The second device receives the uplink signal sent by the first device by using the uplink transmit power. For example, the uplink transmit power is a sum of the uplink open-loop power parameter of the first device and the self-interference compensation amount of the second device. Therefore, adverse impact caused by a self-interference residual of a signal sent by the second device on reception of an uplink signal can be eliminated or reduced by transmitting the signal by the first device by using the uplink transmit power.

In conclusion, in this embodiment of the present invention, a second device determines a self-interference compensation amount of the second device, generates power indication information according to the self-interference compensation amount, sends the power indication information to a first device, and finally receives an uplink signal sent by the first device by using uplink transmit power. In this embodiment of the present invention, adverse impact caused by a self-interference residual amount of the second device on reception of an uplink signal is reduced by using the self-interference compensation amount of the second device, or adverse impact caused by a self-interference residual amount of the second device on reception of an uplink signal is eliminated by sending the uplink signal by the first device by using maximum transmit power. Therefore, in this embodiment of the present invention, the adverse impact caused by the self-interference residual amount of the second device on the reception of the uplink signal can be eliminated or reduced, a signal-to-noise ratio of the received uplink signal can be increased, and network performance can be enhanced.

Optionally, in another embodiment, in step 410, the second device generates the power indication information according to the self-interference compensation amount, and the power indication information is used to indicate the self-interference compensation amount, so that the first device determines the uplink transmit power according to the self-interference compensation amount and an uplink open-loop power parameter.

When the second device is a base station, the base station may schedule all subframes (time-frequency resources) for full-duplex transmission. Therefore, in each uplink subframe, the first device needs to add a self-interference compensation amount to an open-loop parameter, to adjust uplink transmit power of the first device. Specifically, the first device adds the self-interference compensation amount to an open-loop power parameter that affects each channel, such as open-loop power of a PUCCH channel in LTE or open-loop power of a PUSCH in LTE. That is, the uplink transmit power of the first device is power determined according to a sum of the uplink open-loop power parameter of the first device and the self-interference compensation amount of the second device.

Alternatively, when the second device is a relay, the relay may schedule all subframes (time-frequency resources) for full-duplex transmission. In one case, the first device is user equipment, and the relay sends a downlink signal to a base station and receives an uplink signal from a terminal. In this case, the terminal adds a self-interference compensation amount to an open-loop parameter or a close-loop parameter, to adjust uplink transmit power of the user equipment. Specifically, the first device adds the self-interference compensation amount to an open-loop power parameter that affects each channel, such as open-loop power of a PUCCH channel in LTE or open-loop power of a PUSCH in LTE. That is, the uplink transmit power of the first device is a sum of the uplink open-loop power parameter of the first device and the self-interference compensation amount of the second device. In another case, the first device is a base station, and the relay sends a downlink signal to user equipment and receives an uplink signal from the base station. Similarly, the base station adds a self-interference residual compensation amount of the relay to an open-loop parameter or a close-loop parameter, to adjust uplink transmit power of the base station. Specifically, the base station adds a self-interference residual offset to an open-loop parameter or a close-loop parameter such as open-loop power of a PUCCH channel or open-loop power of a PUSCH. That is, the uplink transmit power of the first device is power determined according to a sum of the uplink open-loop power parameter of the first device and the self-interference compensation amount of the second device.

For example, uplink power control in LTE is a manner in which open-loop power control is combined with close-loop correction.

For example, power of a PUSCH in a subframe i is defined as:

$${P}_{PUSCH , c} ( i ) = min \{ \begin{matrix}{P}_{CMAX , c} ( i ) , \\ 10 {log}_{10} ( {M}_{PUSCH , c} ( i ) ) + {P}_{O \_ PUSCH , c} ( j ) + {α}_{c} ( j ) \cdot {PL}_{c} + {Δ}_{TF , c} ( i ) + {f}_{c} ( i ) \end{matrix} \} [ dBm ] ,$$

where P_{CMAX,c}(i) indicates maximum transmit power of a terminal, M_{PUSCH,c}(i) indicates an RB quantity allocated based on an uplink grant, P_{O}_{_}_{PUSCH,c}(j) indicates an open-loop power parameter, α_{c}(j) indicates a path loss factor, PL_{c} indicates a downlink path loss estimation amount, Δ_{TF,c}(i) indicates a transmission manner compensation amount, and f_{c}(i) indicates a dynamic power control offset.

A value of j is 0, 1, or 2, where 0 indicates uplink transmission based on semi-persistent scheduling, 1 indicates uplink transmission based on dynamic scheduling, and 2 indicates uplink transmission based on random access.

P_{O}_{_}_{PUSCH,c}(0)=P_{O}_{_}_{NOMINAL}_{_}_{PUSCH,c}(0)+P_{O} _{_}_{UE}_{_}_{PUSCH,c}(0)

P_{O}_{_}_{PUSCH,c}(1)=P_{O}_{_}_{NOMINAL}_{_}_{PUSCH,c}(1)+P_{O} _{_}_{UE}_{_}_{PUSCH,c}(1)

P_{O}_{_}_{NOMINAL}_{_}_{PUSCH,c}(2)=P_{O}_{_}_{PRE}+Δ_{PREAMBLE}_{_}_{Msg3}

P_{O}_{_}_{NOMINAL}_{_}_{PUSCH,c}(j)

is a cell-specific parameter that is indicated by using higher layer signaling and that is broadcasted to a terminal, P_{O}_{_}_{UE}_{_}_{PUSCH,c}(j) is a UE-specific component that is configured by using RRC signaling, and P_{O}_{_}_{PRE} and Δ_{PREAMBLE}_{_}_{Msg3} are higher layer parameters for random access.

When uplink signals are simultaneously transmitted on a PUSCH and a PUCCH,

$${P}_{PUSCH , c} ( i ) = min \{ \begin{matrix}10 {log}_{10} ( {\hat{P}}_{CMAX , c} ( i ) {\hat{P}}_{PUCCH} ( i ) ) , \\ 10 {log}_{10} ( {M}_{PUSCH , c} ( i ) ) + {P}_{O \_ PUSCH , c} ( j ) + {α}_{c} ( j ) \cdot {PL}_{c} + {Δ}_{TF , c} ( i ) + {f}_{c} ( i ) \end{matrix} \} [ dBm ] ,$$

where \hat{P}_{PUCCH}(i) is power of the PUCCH in the subframe i. P_{O}_{_}_{PUSCH,c}(j) is affected by a self-interference residual amount, thereby affecting P_{PUSCH,c}(i).

After a self-interference compensation amount Δ_{SI}(j) of a base station is considered, a transmit power formula is modified to:

$${P}_{PUSCH , c} ( i ) = min \{ \begin{matrix}{P}_{CMAX , c} ( i ) , \\ 10 {log}_{10} ( {M}_{PUSCH , c} ( i ) ) + {P}_{O \_ PUSCH , c} ( j ) + {Δ}_{SI} ( j ) + {α}_{c} ( j ) \cdot {PL}_{c} + {Δ}_{TF , c} ( i ) + {f}_{c} ( i ) \end{matrix} \} [ dBm ] , \\ or \\ {P}_{PUSCH , c} ( i ) = min \{ \begin{matrix}10 {log}_{10} ( {\hat{P}}_{CMAX , c} ( i ) - {\hat{P}}_{PUCCH} ( i ) ) , \\ 10 {log}_{10} ( {M}_{PUSCH , c} ( i ) ) + {P}_{O \_ PUSCH , c} ( j ) + {Δ}_{SI} ( j ) + {α}_{c} ( j ) \cdot {PL}_{c} + {Δ}_{TF , c} ( i ) + {f}_{c} ( i ) \end{matrix} \} [ dBm ] .$$

Higher layer signaling P_{O}_{_}_{NOMINAL}_{_}_{PUSCH,c}(j) is broadcasted to the terminal by using higher layer signaling, and P_{O}_{_}_{UE}_{_}_{PUSCH,c}(j) is configured for the terminal by using RRC signaling. Therefore, the terminal may be notified of Δ_{SI}(j) by using signaling carrying P_{O}_{_}_{NOMINAL}_{_}_{PUSCH,c}(j) or P_{O}_{_}_{UE}_{_}_{PUSCH,c}(j), or new configured signaling, so as to compensate an open-loop power parameter.

Similarly, on a PUCCH channel, power of the PUCCH in the subframe i is defined as:

$${P}_{PUCCH} ( i ) = min \{ \begin{matrix}{P}_{CMAX , c} ( i ) , \\ {P}_{0 \_ PUCCH} + {PL}_{c} + h ( {n}_{CQI} , {n}_{HARQ} , {n}_{SR} ) + {Δ}_{F \_ PUCCH} ( F ) + {Δ}_{Txd} ( {F}^{′} ) + g ( i ) \end{matrix} \} [ dBm ] ,$$

where

h(n_{CQI},n_{HARQ},n_{SR}) is a parameter of a PUCCH format and is used for transmitting a CQI (channel quality indicator), an HARQ (hybrid automatic repeat request) feedback, and an SR (scheduling request).

P_{O}_{_}_{PUCCH}=P_{O}_{_}_{NOMINAL}_{_}_{PUCCH}+P_{O}_{_}_{UE}_{_}_{PUCCH}.

An open-loop power parameter P_{O}_{_}_{PUCCH} is affected by self-interference, thereby affecting P_{PUCCH}(i). After a self-interference compensation amount Δ_{SI} is considered,

$${P}_{PUCCH} ( i ) = min \{ \begin{matrix}{P}_{CMAX , c} ( i ) , \\ {P}_{0 \_ PUCCH} + {Δ}_{SI} + {PL}_{c} + h ( {n}_{CQI} , {n}_{HARQ} , {n}_{SR} ) + {Δ}_{F \_ PUCCH} ( F ) + {Δ}_{Txd} ( {F}^{′} ) + g ( i ) \end{matrix} \} [ dBm ] .$$

Similarly, P_{O}_{_}_{PUCCH} may be carried by using multiple types of signaling. Therefore, the terminal may be notified of Δ_{SI} by using signaling carrying P_{O}_{_}_{NOMINAL}_{_}_{PUCCH} or P_{O}_{_}_{UE}_{_}_{PUCCH}, or new configured signaling, so as to compensate an open-loop power parameter.

In addition, when a neighboring base station of a full-duplex base station is also in a full-duplex mode, even if there is no self-interference, inter-base station interference to the base station is greater than that to the base station in a half-duplex mode. Therefore, open-loop power parameters are different in two cases and are respectively used for a half-duplex uplink subframe and an uplink subframe in which the base station operates in a full-duplex mode. The base station needs to notify a terminal of two open-loop power parameters, and the terminal compensates a self-interference compensation amount to an open-loop power parameter of the uplink subframe in which the base station operates in a full-duplex mode.

Alternatively, in another embodiment, in step 410, the second device generates the power indication information according to the self-interference compensation amount, and the power indication information is used to indicate the uplink transmit power.

In other words, the second device directly determines the uplink transmit power of the first device and sends the uplink transmit power to the first device by using the power indication information. The first device directly uses the uplink transmit power to send an uplink signal, without performing other calculation.

Specifically, there are two cases. In one case, the first device sends an uplink signal on a full-duplex time-frequency resource. In the other case, the first device sends an uplink signal on a half-duplex time-frequency resource. Two different power parameters are corresponding to the two cases. Specifically, power for sending the uplink signal on the full-duplex time-frequency resource is power determined by the second device according to the self-interference compensation amount of the second device. The uplink transmit power is a sum of the uplink open-loop power parameter of the first device and the self-interference compensation amount of the second device. Power for sending the uplink signal on the half-duplex time-frequency resource may be directly determined by the second device without considering the self-interference compensation amount of the second device. Then the second device notifies the first device that the uplink transmit power may be the uplink open-loop power parameter of the first device.

Therefore, corresponding to the first case, in another embodiment, in step 430, the second device receives, on a full-duplex time-frequency resource, the uplink signal sent by the first device by using the uplink transmit power.

Corresponding to the second case, the method in this embodiment of the present invention further includes: generating, by the second device, information for indicating second power; and sending, by the second device to the first device, the information for indicating the second power, so that the second device that operates in a half-duplex mode receives, on a second time-frequency resource, another uplink signal sent by the first device by using the second power.

It should be understood that, the first time-frequency resource may be a full-duplex time-frequency resource, and the second time-frequency resource may be a half-duplex time-frequency resource.

Specifically, when the second device is a base station, the base station may schedule some subframes for full-duplex transmission and reserve some subframe resources for half-duplex uplink transmission. Interference to the half-duplex uplink transmission is different from interference to uplink transmission in the full-duplex transmission. Therefore, two different power adjustment parameters are required for respectively performing power control in the half-duplex uplink transmission and power control in the uplink transmission in the full-duplex transmission.

The first device sends an uplink signal to the second device on a full-duplex time-frequency resource by using the uplink transmit power, and the first device sends an uplink signal to the second device on a half-duplex time-frequency resource by using the second power.

Interference in a full-duplex subframe is completely different from interference in a half-duplex subframe, and not only interference of a self-interference residual amount but also downlink interference from a neighboring station exist in a full-duplex uplink subframe. Therefore, one power control parameter cannot be shared, and a self-interference residual offset is considered for a power control parameter on a full-duplex time-frequency resource.

Alternatively, when the second device is a relay, in one possible case, the relay sends data to a base station and receives data from a terminal. On subframe resources used for transmitting uplink data by the terminal, if the relay is in a full-duplex state in some subframes and is in a half-duplex state in some other subframes (the relay receives uplink data from the terminal), because interference to half-duplex uplink transmission is different from interference to uplink transmission in full-duplex transmission, two different power adjustment parameters may be used to respectively perform power control in the half-duplex uplink transmission and power control in the uplink transmission in the full-duplex transmission. That is, the first device sends an uplink signal to the second device on a full-duplex time-frequency resource by using the uplink transmit power, and the first device sends another uplink signal to the second device on a half-duplex time-frequency resource by using the second power. In another possible case, similar to the foregoing case, the relay sends data to user equipment and receives data from a base station. To avoid repetition, details are not repeatedly described.

Optionally, in another embodiment, the method is applied to an uplink band in an FDD system, and before the second device determines the self-interference compensation amount of the second device, the method in this embodiment of the present invention further includes: setting, by the second device, a half-duplex downlink time-frequency resource on the uplink band, where the half-duplex downlink time-frequency resource is used to measure the self-interference compensation amount of the second device.

To measure a self-interference residual amount, a base station or a relay needs to add a half-duplex downlink resource onto the uplink band for measuring the self-interference residual amount, and notifies a terminal, or the base station and a terminal of the self-interference residual amount. Similar to a design in TDD, a downlink resource of this type is not essential for each subframe.

To reduce handovers performed by the terminal, or the base station and the terminal on different bands, a downlink time division resource or a downlink frequency division resource on the uplink band is used for a self-interference measurement and used as a resource for notifying a self-interference residual parameter.

In addition, the base station and the terminal can perform receiving on an FDD uplink band. Further, in view of a design of a terminal with low costs, the terminal operates in a half-duplex mode on the FDD uplink band. Therefore, an uplink-downlink handover time is reserved.

Further, in another embodiment, a period in which the half-duplex downlink time-frequency resource is set on the FDD uplink band is greater than or equal to one radio frame.

In other words, a half-duplex downlink time-frequency resource is not set in each frame on the uplink band in the FDD uplink band. The half-duplex downlink time-frequency resource may be set in each frame on the uplink band in the FDD uplink band, or the half-duplex downlink time-frequency resource may be set at intervals of several frames.

Specifically, to measure a self-interference residual amount, a base station or a relay needs to divide some resources on the uplink band as half-duplex downlink resources for measuring the self-interference residual amount, and notifies a terminal, or the base station and a terminal of the self-interference residual amount. Similar to a design in TDD, a downlink resource of this type is not essential for each subframe. To reduce handovers performed by the terminal, or the base station and the terminal on different bands, a downlink time division resource or a downlink frequency division resource on the uplink band is used for a self-interference measurement and used as a resource for notifying a self-interference compensation amount parameter.

Optionally, in another embodiment, the first time-frequency resource is used by a third device to receive a downlink signal sent by the second device, the first device and the third device are a pair of devices whose inter-device interference is less than a preset threshold, and the second device predetermines that interference between the first device and the third device is less than the preset threshold.

In other words, the first device is a first terminal in a first terminal pair, and the first terminal pair includes the first terminal and a second terminal. The first terminal pair is a terminal pair whose inter-terminal interference is less than the preset threshold and that is in all terminal pairs including a first terminal group and a second terminal group. The second terminal receives, on a full-duplex time-frequency resource on which the first terminal sends an uplink signal to the second device, a downlink signal sent by the second device.

Specifically, before the first device sends the uplink signal on the full-duplex time-frequency resource, a terminal sends an uplink control signal, an uplink data signal, or an uplink sounding signal in the half-duplex uplink transmission subframe. The uplink control signal, the uplink data signal, and the uplink sounding signal are respectively corresponding to a PUCCH, a PUSCH, and an SRS signal in an LTE system. A base station uses a resource of this type to schedule some terminals in the first terminal group including the first device to transmit an uplink sounding signal, and to schedule some terminals in the second terminal group including the third device to receive an uplink sounding signal. It should be noted that, if different modulation schemes are used in an uplink and a downlink, a terminal in the second terminal group needs to be capable of performing sending and receiving in two different modulation schemes. For example, in LTE, an SC-FDMA modulation scheme is used in an uplink, and an OFDM modulation scheme is used in a downlink. The terminal in the second terminal group needs to be capable of performing SC-FDMA demodulation. Terminals (some terminals in the second terminal group) in a receiving state measure interference between other terminals within coverage of the second device. Therefore, some terminals are arranged to perform measurements on uplink resources, and to assist the terminals in interference measurements, the base station adds, to an uplink sounding signal, information for sending an SRS, and the second device reserves a resource for measuring and reporting inter-user interference information. When scheduling a full-duplex subframe, the base station selects a pair of devices (the first device and the third device) whose interference is less than the preset threshold, to separately send an uplink signal and receive a downlink signal on a same time-frequency resource.

Optionally, in another embodiment, the method is applied to a downlink band in the FDD system and further includes: setting, by the second device, a half-duplex uplink time-frequency resource on the downlink band, where the half-duplex uplink time-frequency resource is used to measure the interference between the first device and the third device.

Specifically, when the second device is a base station, the method is applied to the downlink band in the FDD system. The second device needs to set the half-duplex uplink time-frequency resource on the downlink band, and the half-duplex uplink time-frequency resource is used to measure the interference between the first device and the third device. The second device predetermines that the interference between the first device and the third device is less than the preset threshold. Then the second device receives, on the full-duplex time-frequency resource, the uplink signal sent by the first device by using the uplink transmit power, and sends a downlink signal to the third device on the full-duplex time-frequency resource.

Optionally, in another embodiment, the method in this embodiment of the present invention further includes: sending, by the second device, a first downlink signal on a full-duplex time-frequency resource according to a first transmission parameter, where the first transmission parameter makes interference between the second device and a neighboring station of the second device less than a preset interference threshold; and sending, by the second device, a second downlink signal on a half-duplex time-frequency resource according to a second transmission parameter.

Specifically, the second device may be a base station. The second device sends downlink signals by using two transmission parameters including the first transmission parameter and the second transmission parameter. The first transmission parameter may be used as a transmission parameter for a full-duplex subframe in which a full-duplex device (the second device) operates. The other type is used as a transmission parameter for a half-duplex subframe in which a full-duplex device operates.

It should be understood that, transmission parameters may include parameters such as transmit power, an antenna downtilt angle, a propagation model, an antenna height of a base station.

If all subframes are used for full-duplex transmission, downlink coverage of the base station (the second device) cannot be ensured. Therefore, to ensure coverage of the base station, the base station may need to reserve some subframes for half-duplex downlink transmission. In addition, if a same transmission parameter is used by the base station in a half-duplex downlink and in a downlink of a full-duplex subframe, strong interference is caused to uplink receiving by a neighboring base station. Therefore, a downlink parameter used by the base station in the downlink needs to be different from that used in a half-duplex downlink subframe.

The base station needs to calculate in advance maximum values of transmit power and a downtilt angle by using parameters such as an inter-cell distance, a propagation model, an antenna height of a base station, so as to reduce inter-base station interference to reception of uplink data. In a full-duplex subframe transmission process, the transmit power and the downtilt angle cannot exceed the foregoing maximum values.

It should be understood that, in the foregoing embodiments, for example, the first device may send an uplink signal on a full-duplex time-frequency resource or a half-duplex time-frequency resource, and the first device may further receive a downlink signal from the second device on another full-duplex time-frequency resource or another half-duplex time-frequency resource. It should be noted that, the first device may send an uplink signal on a full-duplex time-frequency resource or a half-duplex time-frequency resource, but a device that receives a downlink signal from the second device on another full-duplex time-frequency resource or another half-duplex time-frequency resource may be another device instead of the first device. This is not limited in this embodiment of the present invention.

Further, in another embodiment, the method in this embodiment of the present invention may further include: determining, by the second device, a fourth device whose SINR is greater than a preset threshold or whose CQI is greater than a preset channel quality threshold, where the fourth device includes at least one device; determining, by the second device, a fifth device whose PH is greater than a preset headroom threshold, where the fifth device includes at least one device; and receiving, by the second device on the full-duplex time-frequency resource, an uplink signal sent by the fifth device.

The sending, by the second device, a first downlink signal on a full-duplex time-frequency resource according to a first transmission parameter includes: sending, by the second device, the first downlink signal to the at least one device in the fourth device on the full-duplex time-frequency resource according to the first transmission parameter.

It should be understood that, the fifth device and the first device may be a same device or different devices. This is not limited in this embodiment of the present invention.

Specifically, when scheduling a full-duplex subframe, the second device schedules a device whose SINR is greater than the preset threshold to receive a downlink signal.

In addition, when scheduling a full-duplex subframe, the second device may schedule the fifth device whose PH is greater than the preset headroom threshold to send an uplink signal. In a half-duplex communications system, a base station learns a PH of a terminal by using a PHR fed back by the terminal. When a PH is high, it indicates that the terminal may send an uplink signal by using greater transmit power, so as to eliminate self-interference impact.

It should be understood that, in an example of this embodiment, when scheduling a full-duplex subframe, the second device may schedule a device whose SINR is greater than the preset threshold or whose CQI is greater than the preset channel quality threshold to receive a downlink signal. When scheduling the full-duplex subframe, the second device may schedule any device to receive the downlink signal. This is not limited in this embodiment of the present invention.

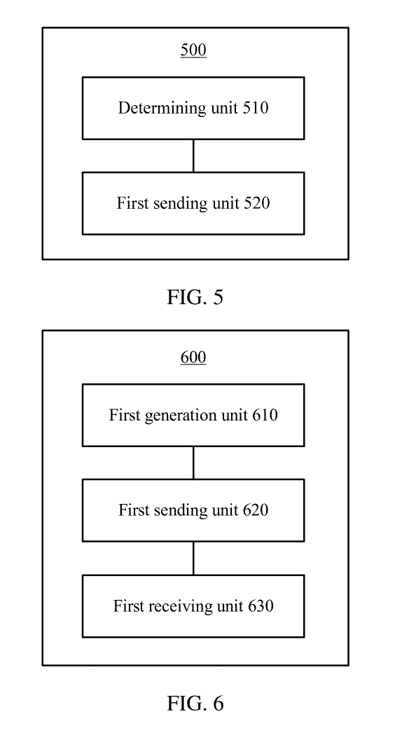

With reference to FIG. 1 to FIG. 4, signal transmission methods in the embodiments of the present invention are described above in detail. With reference to FIG. 5 to FIG. 8, devices in the embodiments of the present invention are described below in detail.

FIG. 5 is a schematic block diagram of a signal transmission device according to an embodiment of the present invention. A device 500 that is shown in FIG. 5 and that is applied to the scenario in FIG. 1 is user equipment, and a second device is a base station. Alternatively, a device 500 that is shown in FIG. 5 and that is applied to the scenario in FIG. 2 is a base station or user equipment, and a second device is a relay. The device 500 shown in FIG. 5 includes a determining unit 510 and a first sending unit 520.

Specifically, the determining unit 510 determines uplink transmit power, and the first sending unit 520 sends, on a first time-frequency resource by using the uplink transmit power, an uplink signal to the second device that operates in a full-duplex mode. The uplink transmit power is power determined according to a self-interference compensation amount of the second device, or the uplink transmit power is maximum transmit power of a first device.

In conclusion, in this embodiment of the present invention, a signal transmission device sends, by using uplink transmit power, an uplink signal to a second device that operates in a full-duplex mode, and the uplink transmit power is power determined according to a self-interference compensation amount of the second device, or the uplink transmit power is maximum transmit power of the device. In this embodiment of the present invention, adverse impact caused by a self-interference residual amount of the second device on reception of an uplink signal is reduced by using the self-interference compensation amount of the second device, or adverse impact caused by a self-interference residual amount of the second device on reception of an uplink signal is eliminated by sending the uplink signal by the device by using the maximum transmit power. Therefore, in this embodiment of the present invention, the adverse impact caused by the self-interference residual amount of the second device on the reception of the uplink signal can be eliminated or reduced, and network performance can be enhanced.

Optionally, in another embodiment, the determining unit 510 obtains power indication information sent by the second device, and determines the uplink transmit power according to the self-interference compensation amount and an uplink open-loop power parameter. The power indication information is used to indicate the self-interference compensation amount of the second device.

Optionally, in another embodiment, the uplink open-loop power parameter includes a first uplink open-loop power parameter or a second uplink open-loop power parameter. The determining unit 510 determines the uplink transmit power according to the self-interference compensation amount and the first uplink open-loop power parameter; or the determining unit 510 determines the uplink transmit power according to the self-interference compensation amount and the second uplink open-loop power parameter.

Optionally, in another embodiment, the determining unit 510 obtains power indication information sent by the second device, and the power indication information is used to indicate the uplink transmit power.

Optionally, in another embodiment, the device 500 further includes: an obtaining unit, configured to obtain information that is used for indicating second power and that is sent by the second device; and a second sending unit, configured to send, on a second time-frequency resource by using the second power, an uplink signal to the second device that operates in a half-duplex mode.

Optionally, in another embodiment, the first time-frequency resource is used by a third device to receive a downlink signal sent by the second device, the device 500 and the third device are a pair of devices whose inter-device interference is less than a preset threshold, and the second device predetermines that interference between the device 500 and the third device is less than the preset threshold.

Optionally, in another embodiment, the device 500 is applied to a downlink band in an FDD system, and the interference between the device 500 and the third device is measured by using a half-duplex uplink time-frequency resource that is set by the second device on the downlink band.

Optionally, in another embodiment, the device 500 further includes: a first measurement unit, configured to perform CRS-related measurement between the device 500 and the second device according to a received CRS sent by the second device by using a first transmission parameter; and a second measurement unit, configured to perform CRS-related measurement between the device 500 and the second device according to a received CRS sent by the second device by using a second transmission parameter.

Optionally, in another embodiment, the self-interference compensation amount is determined by the second device according to the following formula:

Δ_{SI}=10*log₁₀(N+1) dB

where Δ_{SI} indicates the self-interference compensation amount, N indicates that self-interference residual power is N multiples of noise power, and N>0.

It should be understood that, the device 500 shown in FIG. 5 can implement all processes completed by the first device in the methods shown in FIG. 3 and FIG. 4. For specific description, refer to description of the methods shown in FIG. 3 and FIG. 4. To avoid repetition, details are not repeatedly described herein.

FIG. 6 is a schematic block diagram of a signal transmission device according to another embodiment of the present invention. A device 600 that is shown in FIG. 6 and that is applied to the scenario in FIG. 1 is a base station, and a first device is user equipment. Alternatively, a device 600 that is shown in FIG. 6 and that is applied to the scenario in FIG. 2 is a relay, and a first device is a base station or user equipment. The device 600 shown in FIG. 6 includes a first generation unit 610, a first sending unit 620, and a first receiving unit 630.

Specifically, the first generation unit 610 generates power indication information. The power indication information is used by the first device to determine, according to the power indication information, uplink transmit power for sending an uplink signal to the device 600 that operates in a full-duplex mode, and the uplink transmit power is power determined according to a self-interference compensation amount of the device 600, or the uplink transmit power is maximum transmit power of the first device. The first sending unit 620 sends the power indication information to the first device. The first receiving unit 630 receives an uplink signal sent by the first device on a first time-frequency resource by using the uplink transmit power.

In conclusion, in this embodiment of the present invention, a device generates power indication information for indicating uplink transmit power, sends the power indication information to a first device, and receives an uplink signal sent by the first device on a first time-frequency resource by using the uplink transmit power. In this embodiment of the present invention, adverse impact caused by a self-interference residual amount of the device 600 on reception of an uplink signal is reduced by using a self-interference compensation amount of the device 600, or adverse impact caused by a self-interference residual amount of a second device on reception of an uplink signal is eliminated by sending the uplink signal by the first device by using maximum transmit power. Therefore, in this embodiment of the present invention, the adverse impact caused by the self-interference residual amount of the second device on the reception of the uplink signal can be eliminated or reduced, and network performance can be enhanced.

Optionally, in another embodiment, the device 600 further includes: a first determining unit, configured to determine the self-interference compensation amount of the device 600. The first generation unit 610 generates the power indication information according to the self-interference compensation amount.

In conclusion, in this embodiment of the present invention, a signal transmission device determines a self-interference compensation amount of the device 600, generates power indication information according to the self-interference compensation amount, sends the power indication information to a first device, and finally receives an uplink signal sent by the first device by using uplink transmit power. In this embodiment of the present invention, adverse impact caused by a self-interference residual amount on reception of an uplink signal is reduced by using the self-interference compensation amount of the signal transmission device, or adverse impact caused by a self-interference residual amount of the device 600 on reception of an uplink signal is eliminated by sending the uplink signal by the first device by using maximum transmit power. Therefore, in this embodiment of the present invention, the adverse impact caused by the self-interference residual amount of the device 600 on the reception of the uplink signal can be eliminated or reduced, and network performance can be enhanced.

Optionally, in another embodiment, the first generation unit 610 generates the power indication information according to the self-interference compensation amount, and the power indication information is used to indicate the self-interference compensation amount, so that the first device determines the uplink transmit power according to the self-interference compensation amount and an uplink open-loop power parameter.

Alternatively, in another embodiment, the first generation unit 610 generates the power indication information according to the self-interference compensation amount, and the power indication information is used to indicate the uplink transmit power.

Optionally, in another embodiment, the device 600 further includes: a second generation unit, configured to generate information for indicating second power; and a second sending unit, configured to send, to the first device, the information for indicating the second power, so that the device 600 that operates in a half-duplex mode receives, on a second time-frequency resource, another uplink signal sent by the first device by using the second power.

Optionally, in another embodiment, the device 600 is applied to an uplink band in an FDD system and further includes: a first setting unit, configured to set a half-duplex downlink time-frequency resource on the uplink band. The half-duplex downlink time-frequency resource is used to measure the self-interference compensation amount of the second device.

Further, in another embodiment, a period in which the half-duplex downlink time-frequency resource is set on the uplink band is greater than or equal to one radio frame.

Optionally, in another embodiment, the first time-frequency resource is used by a third device to receive a downlink signal sent by the device 600, the first device and the third device are a pair of devices whose inter-device interference is less than a preset threshold, and the device 600 predetermines that interference between the first device and the third device is less than the preset threshold.

Optionally, in another embodiment, the device 600 is applied to a downlink band in the FDD system and further includes: a second setting unit, configured to set a half-duplex uplink time-frequency resource on the downlink band. The half-duplex uplink time-frequency resource is used to measure the interference between the first device and the third device.

Optionally, in another embodiment, the device 600 further includes: a third sending unit, configured to send a first downlink signal on a full-duplex time-frequency resource according to a first transmission parameter, where the first transmission parameter makes interference between the second device and a neighboring station of the second device less than a preset interference threshold; and a fourth sending unit, configured to send a second downlink signal on a half-duplex time-frequency resource according to a second transmission parameter.

Optionally, in another embodiment, the device 600 further includes: a second determining unit, configured to determine a fourth device whose SINR is greater than a preset threshold or whose CQI is greater than a preset channel quality threshold, where the fourth device includes at least one device; a third determining unit, configured to determine a fifth device whose PH is greater than a preset headroom threshold, where the fifth device includes at least one device; and a second receiving unit, configured to receive, on the full-duplex time-frequency resource, an uplink signal sent by the fifth device. The third sending unit sends the first downlink signal to the at least one device in the fourth device on the full-duplex time-frequency resource according to the first transmission parameter.

Optionally, in another embodiment, the first determining unit 610 determines the self-interference compensation amount of the second device according to the following formula:

Δ_{SI}=10*log₁₀(N+1) dB

where Δ_{SI} indicates the self-interference compensation amount, N indicates that self-interference residual power is N multiples of noise power, and N>0.

It should be understood that, the device 600 shown in FIG. 6 can implement all processes completed by the second device in the methods shown in FIG. 3 and FIG. 4. For specific description, refer to description of the methods shown in FIG. 3 and FIG. 4. To avoid repetition, details are not repeatedly described herein.

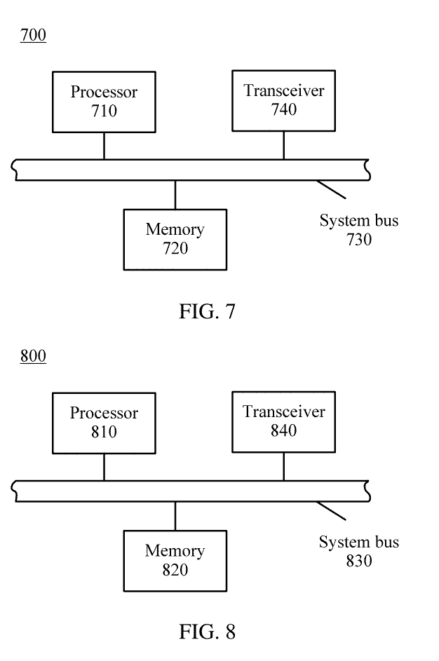

FIG. 7 is a schematic block diagram of a signal transmission device according to another embodiment of the present invention. A device 700 that is shown in FIG. 7 and that is applied to the scenario in FIG. 1 is user equipment, and a second device is a base station. Alternatively, a device 700 that is shown in FIG. 7 and that is applied to the scenario in FIG. 2 is a base station or user equipment, and a second device is a relay. The device 700 shown in FIG. 7 includes a processor 710, a memory 720, a bus system 730, and a transceiver 7400.

Specifically, the processor 710 determines uplink transmit power by invoking, by using the bus system 730, code stored in the memory 720. The transceiver 740 sends, on a first time-frequency resource by using the uplink transmit power, an uplink signal to the second device that operates in a full-duplex mode. The uplink transmit power is power determined according to a self-interference compensation amount of the second device, or the uplink transmit power is maximum transmit power of a first device.

In conclusion, in this embodiment of the present invention, a signal transmission device sends, by using uplink transmit power, an uplink signal to a second device that operates in a full-duplex mode, and the uplink transmit power is power determined according to a self-interference compensation amount of the second device, or the uplink transmit power is maximum transmit power of the device 700. In this embodiment of the present invention, adverse impact caused by a self-interference residual amount of the second device on reception of an uplink signal is reduced by using the self-interference compensation amount of the second device, or adverse impact caused by a self-interference residual amount of the second device on reception of an uplink signal is eliminated by sending the uplink signal by the device 700 by using the maximum transmit power. Therefore, in this embodiment of the present invention, the adverse impact caused by the self-interference residual amount of the second device on the reception of the uplink signal can be eliminated or reduced, and network performance can be enhanced.

The methods disclosed in the foregoing embodiments of the present invention may be applied to the processor 710, or implemented by the processor 710. The processor 710 may be an integrated circuit chip and has a signal processing capability. In an implementation process, the steps in the foregoing methods may be completed by using an integrated logic circuit of hardware in the processor 710 or an instruction in a form of software. The foregoing processor 710 may be a general purpose processor, a digital signal processor (DSP), an application-specific integrated circuit (ASIC), a field programmable gate array (FPGA) or another programmable logic device, a discrete gate or a transistor logic device, or a discrete hardware component. The processor 710 can implement or execute methods, steps, and logical block diagrams disclosed in the embodiments of the present invention. The general purpose processor may be a microprocessor, or the processor may be any conventional processor or the like. The steps of the methods disclosed with reference to the embodiments of the present invention may be directly performed by a hardware decoding processor, or performed by using a combination of hardware in a decoding processor and a software module. The software module may be located in a mature storage medium in the art, such as a random access memory (RAM), a flash memory, a read-only memory (ROM), a programmable read-only memory, an electrically-erasable programmable memory, or a register. The storage medium is located in the memory 720. The processor 710 reads information in the memory 720, and completes the steps of the foregoing methods in combination with the hardware in the processor 710. In addition to a data bus, the bus system 730 may include a power supply bus, a control bus, a status signal bus, and the like. However, for clarity of description, various buses are marked as the bus system 730 in the figure.

Optionally, in another embodiment, the processor 710 obtains power indication information sent by the second device, and determines the uplink transmit power according to the self-interference compensation amount and an uplink open-loop power parameter. The power indication information is used to indicate the self-interference compensation amount of the second device.

Optionally, in another embodiment, the uplink open-loop power parameter includes a first uplink open-loop power parameter or a second uplink open-loop power parameter. The processor 710 determines the uplink transmit power according to the self-interference compensation amount and the first uplink open-loop power parameter; or the processor 710 determines the uplink transmit power according to the self-interference compensation amount and the second uplink open-loop power parameter.

Optionally, in another embodiment, the processor 710 obtains power indication information sent by the second device, and the power indication information is used to indicate the uplink transmit power.

Optionally, in another embodiment, the transceiver 740 obtains information that is used for indicating second power and that is sent by the second device; and sends, on a second time-frequency resource by using the second power, an uplink signal to the second device that operates in a half-duplex mode.

Optionally, in another embodiment, the first time-frequency resource is used by a third device to receive a downlink signal sent by the second device, the device 700 and the third device are a pair of devices whose inter-device interference is less than a preset threshold, and the second device predetermines that interference between the device 700 and the third device is less than the preset threshold.

Optionally, in another embodiment, the device 700 is applied to a downlink band in an FDD system, and the interference between the device 700 and the third device is measured by using a half-duplex uplink time-frequency resource that is set by the second device on the downlink band.

Optionally, in another embodiment, the processor 710 performs CRS-related measurement between the device 700 and the second device according to a received CRS sent by the second device by using a first transmission parameter, and performs CRS-related measurement between the device 700 and the second device according to a received CRS sent by the second device by using a second transmission parameter.

Optionally, in another embodiment, the self-interference compensation amount is determined by the second device according to the following formula:

Δ_{SI}=10*log₁₀(N+1) dB

where Δ_{SI} indicates the self-interference compensation amount, N indicates that self-interference residual power is N multiples of noise power, and N>0.

It should be understood that, the device 700 shown in FIG. 7 is corresponding to the device 500 shown in FIG. 5 and can implement all processes completed by the first device in the methods shown in FIG. 3 and FIG. 4. For specific description, refer to description of the methods shown in FIG. 3 and FIG. 4. To avoid repetition, details are not repeatedly described herein.

FIG. 8 is a schematic block diagram of a signal transmission device according to another embodiment of the present invention. A device 800 that is shown in FIG. 8 and that is applied to the scenario in FIG. 1 is a base station, and a first device is user equipment. Alternatively, a device 800 that is shown in FIG. 8 and that is applied to the scenario in FIG. 2 is a relay, and a first device is a base station or user equipment. The device 800 shown in FIG. 8 includes a processor 810, a memory 820, a bus system 830, and a transceiver 840.

Specifically, the processor 810 generates power indication information by invoking, by using the bus system 830, code stored in the memory 820. The power indication information is used by the first device to determine, according to the power indication information, uplink transmit power for sending an uplink signal to the device 800 that operates in a full-duplex mode, and the uplink transmit power is power determined according to a self-interference compensation amount of the device 800, or the uplink transmit power is maximum transmit power of the first device. The transceiver 840 sends the power indication information to the first device. The transceiver 840 receives an uplink signal sent by the first device on a first time-frequency resource by using the uplink transmit power.

In conclusion, in this embodiment of the present invention, a device generates power indication information for indicating uplink transmit power, sends the power indication information to a first device, and receives an uplink signal sent by the first device on a first time-frequency resource by using the uplink transmit power. In this embodiment of the present invention, adverse impact caused by a self-interference residual amount of the device 800 on reception of an uplink signal is reduced by using a self-interference compensation amount of the device 800, or adverse impact caused by a self-interference residual amount of the device 800 on reception of an uplink signal is eliminated by sending the uplink signal by the first device by using maximum transmit power. Therefore, in this embodiment of the present invention, the adverse impact caused by a self-interference residual amount of a second device on the reception of the uplink signal can be eliminated or reduced, and network performance can be enhanced.

The methods disclosed in the foregoing embodiments of the present invention may be applied to the processor 810, or implemented by the processor 810. The processor 810 may be an integrated circuit chip and has a signal processing capability. In an implementation process, the steps in the foregoing methods may be completed by using an integrated logic circuit of hardware in the processor 810 or an instruction in a form of software. The foregoing processor 810 may be a general purpose processor, a digital signal processor (DSP), an application-specific integrated circuit (ASIC), a field programmable gate array (FPGA) or another programmable logic device, a discrete gate or a transistor logic device, or a discrete hardware component. The processor 810 can implement or execute methods, steps, and logical block diagrams disclosed in the embodiments of the present invention. The general purpose processor may be a microprocessor, or the processor may be any conventional processor or the like. The steps of the methods disclosed with reference to the embodiments of the present invention may be directly performed by a hardware decoding processor, or performed by using a combination of hardware in a decoding processor and a software module. The software module may be located in a mature storage medium in the art, such as a random access memory (RAM), a flash memory, a read-only memory (ROM), a programmable read-only memory, an electrically-erasable programmable memory, or a register. The storage medium is located in the memory 820. The processor 810 reads information in the memory 820, and completes the steps of the foregoing methods in combination with the hardware in the memory 820. In addition to a data bus, the bus system 830 may include a power supply bus, a control bus, a status signal bus, and the like. However, for clarity of description, various buses are marked as the bus system 830 in the figure.

Optionally, in another embodiment, the processor 810 determines the self-interference compensation amount of the device 800. The processor 810 generates the power indication information according to the self-interference compensation amount.

In conclusion, in this embodiment of the present invention, a signal transmission device determines a self-interference compensation amount of the device 800, generates power indication information according to the self-interference compensation amount, sends the power indication information to a first device, and finally receives an uplink signal sent by the first device by using uplink transmit power. In this embodiment of the present invention, adverse impact caused by a self-interference residual amount on reception of an uplink signal is reduced by using the self-interference compensation amount of the signal transmission device, or adverse impact caused by a self-interference residual amount of the device 800 on reception of an uplink signal is eliminated by sending the uplink signal by the first device by using maximum transmit power. Therefore, in this embodiment of the present invention, the adverse impact caused by the self-interference residual amount of the device 800 on the reception of the uplink signal can be eliminated or reduced, and network performance can be enhanced.

Optionally, in another embodiment, the processor 810 generates the power indication information according to the self-interference compensation amount, and the power indication information is used to indicate the self-interference compensation amount, so that the first device determines the uplink transmit power according to the self-interference compensation amount and an uplink open-loop power parameter.

Alternatively, in another embodiment, the processor 810 generates the power indication information according to the self-interference compensation amount, and the power indication information is used to indicate the uplink transmit power.

Optionally, in another embodiment, the transceiver 840 receives, on a full-duplex time-frequency resource, an uplink signal sent by the first device by using the uplink transmit power. The processor 810 generates information for indicating second power. The transceiver 840 sends, to the first device, the information for indicating the second power, so that the device 800 that operates in a half-duplex mode receives, on a second time-frequency resource, another uplink signal sent by the first device by using the second power.

Optionally, in another embodiment, the device 800 is applied to an uplink band in an FDD system. The processor 810 sets a half-duplex downlink time-frequency resource on the uplink band, and the half-duplex downlink time-frequency resource is used to measure the self-interference compensation amount of the second device.

Further, in another embodiment, a period in which the half-duplex downlink time-frequency resource is set on the uplink band is greater than or equal to one radio frame.

Optionally, in another embodiment, the first time-frequency resource is used by a third device to receive a downlink signal sent by the device 800, the first device and the third device are a pair of devices whose inter-device interference is less than a preset threshold, and the device 800 predetermines that interference between the first device and the third device is less than the preset threshold.

Optionally, in another embodiment, the device 800 is applied to a downlink band in the FDD system. The processor 810 sets a half-duplex uplink time-frequency resource on the downlink band, and the half-duplex uplink time-frequency resource is used to measure the interference between the first device and the third device.

Optionally, in another embodiment, the transceiver 840 sends a first downlink signal on a full-duplex time-frequency resource according to a first transmission parameter, and the first transmission parameter makes interference between the second device and a neighboring station of the second device less than a preset interference threshold. The transceiver 840 sends a second downlink signal on a half-duplex time-frequency resource according to a second transmission parameter.

Optionally, in another embodiment, the processor 810 is configured to determine a fourth device whose SINR is greater than a preset threshold or whose CQI is greater than a preset channel quality threshold, and the fourth device includes at least one device. The processor 810 determines a fifth device whose PH is greater than a preset headroom threshold, and the fifth device includes at least one device. The transceiver 840 receives, on the full-duplex time-frequency resource, an uplink signal sent by the fifth device. The transceiver 840 sends the first downlink signal to the at least one device in the fourth device on the full-duplex time-frequency resource according to the first transmission parameter.

Optionally, in another embodiment, the processor 810 determines the self-interference compensation amount of the second device according to the following formula:

Δ_{SI}=10*log₁₀(N+1) dB

where Δ_{SI} indicates the self-interference compensation amount, N indicates that self-interference residual power is N multiples of noise power, and N>0.

It should be understood that, the device 800 shown in FIG. 8 is corresponding to the device 600 shown in FIG. 6 and can implement all processes completed by the second device in the methods shown in FIG. 3 and FIG. 4. For specific description, refer to description of the methods shown in FIG. 3 and FIG. 4. To avoid repetition, details are not repeatedly described herein.

It should be noted that, the foregoing examples are merely intended to help a person skilled in the art better understand the embodiments of the present invention, instead of limiting the scope of the embodiments of the present invention. A person skilled in the art apparently can make various equivalent modifications or changes according to the examples described above, and such modifications or changes also fall within the scope of the embodiments of the present invention.

It should be understood that, sequence numbers of the foregoing processes do not mean execution sequences. The execution sequences of the processes should be determined according to functions and internal logic of the processes, and should not be construed as any limitation on the implementation processes of the embodiments of the present invention.

It should be understood that, “one embodiment” or “an embodiment” mentioned throughout this specification means that a specific feature, structure, or character related to the embodiment is included in at least one embodiment of the present invention. Therefore, “in one embodiment” or “in an embodiment” described in the entire specification may not necessarily refer to a same embodiment. In addition, these specific features, structures, or characters may be combined in one or more embodiments in any proper manner. It should be understood that, sequence numbers of the foregoing processes do not mean execution sequences in various embodiments of the present invention. The execution sequences of the processes should be determined according to functions and internal logic of the processes, and should not be construed as any limitation on the implementation processes of the embodiments of the present invention.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between associated objects.

It should be understood that, in the embodiments of the present invention, “B corresponding to A” indicates that B is associated with A, and B may be determined according to A. However, it should further be understood that, determining B according to A does not mean that B is determined according to only A, that is, B may be determined according to A and/or other information.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present embodiments.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present invention.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

With descriptions of the foregoing embodiments, a person skilled in the art may clearly understand that the present embodiments may be implemented by hardware, firmware or a combination thereof. When the present embodiments is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation: The computer-readable medium may include a RAM, a ROM, an electrically erasable programmable read only memory (EEPROM), a CD-ROM, or another optical disc storage or disk storage medium, or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in fixation of a medium to which they belong. For example, a disk and disc used by the present embodiments includes a compact disc (CD), a laser disc, an optical disc, a digital versatile disc (DVD), a floppy disk and a Blu-ray disc, where the disk generally copies data by a magnetic means, and the disc copies data optically by a laser means. The foregoing combination should also be included in the protection scope of the computer-readable medium.

In summary, what are described above are merely examples of embodiments of the technical solutions of the present embodiments, but are not intended to limit the protection scope of the present embodiments. Any modification, equivalent replacement, or improvement made without departing from the spirit and principle of the present invention shall fall within the protection scope of the present embodiments.

What is claimed is:

1. A device, comprising:
a processor; and
a non-transitory computer readable storage medium storing a program for execution by the processor, the program including instructions to:
determine uplink transmit power; and
send, on a first time-frequency resource using the uplink transmit power, an uplink signal to a second device that operates in a full-duplex mode, wherein the uplink transmit power is power determined according to a self-interference compensation amount of the second device, or the uplink transmit power is determined to be a maximum transmit power of the device.

2. The device according to claim 1, wherein the instructions further comprise instructions to:
obtain power indication information sent by the second device; and
determine the uplink transmit power according to the self-interference compensation amount and an uplink open-loop power parameter, wherein the power indication information indicates the self-interference compensation amount of the second device.

3. The device according to claim 2, wherein the uplink open-loop power parameter comprises a first uplink open-loop power parameter or a second uplink open-loop power parameter, and wherein the instructions further comprise instructions to:
determine the uplink transmit power according to the self-interference compensation amount and either the first uplink open-loop power parameter or the second uplink open-loop power parameter.

4. The device according to claim 1, wherein the instructions further comprise instructions to:
obtain, from the second device, information that is used for indicating second power; and
send, on a second time-frequency resource using the second power, an uplink signal to the second device that operates in a half-duplex mode.

5. The device according to claim 4, wherein the first time-frequency resource is for a third device to receive a downlink signal, wherein the device and the third device are a pair of devices whose inter-device interference is less than a preset threshold, and wherein interference between the device and the third device is less than the preset threshold.

6. The device according to claim 5, wherein the interference between the device and the third device is measured using a half-duplex uplink time-frequency resource set by the second device on a downlink band.

7. The device according to claim 1, wherein the self-interference compensation amount is determined by the second device according to:
Δ_{SI}=10*log₁₀(N+1) dB
wherein Δ_{SI} indicates the self-interference compensation amount, N indicates that self-interference residual power is N multiples of noise power, and N>0.

8. A device, comprising:
a processor; and
a non-transitory computer readable storage medium storing a program for execution by the processor, the program including instructions to:
generate power indication information;
send the power indication information to a first device; and
receive an uplink signal sent by the first device on a first time-frequency resource by using an uplink transmit power.

9. The device according to claim 8, wherein the instructions further comprise instructions to:
determine the self-interference compensation amount of the device; and
generate the power indication information according to a self-interference compensation amount.

10. The device according to claim 9, wherein the power indication information indicates the self-interference compensation amount.

11. The device according to claim 9, wherein the power indication information indicates the uplink transmit power.

12. The device according to claim 8, wherein the instructions further comprise instructions to:
generate information indicating a second power; and
send, to the first device, the information indicating the second power.

13. The device according to claim 8, wherein the instructions further comprise instructions to:
set a half-duplex downlink time-frequency resource on an uplink band.

14. The device according to claim 13, wherein a period in which the half-duplex downlink time-frequency resource is set on the uplink band is greater than or equal to one radio frame.

15. The device according to claim 8, wherein the first time-frequency resource is for a third device to receive a downlink signal sent by the device, wherein the first device and the third device are a pair of devices whose inter-device interference is less than a preset threshold, and wherein the instructions further comprise instructions to:
predetermine that interference between the first device and the third device is less than the preset threshold.

16. The device according to claim 15, wherein the instructions further comprise instructions to:
set a half-duplex uplink time-frequency resource on the downlink band.

17. The device according to claim 8, wherein the instructions further comprise instructions to:
send a first downlink signal on a full-duplex time-frequency resource according to a first transmission parameter, wherein the first transmission parameter causes interference between the device and a neighboring station of the device less than a preset interference threshold; and
send a second downlink signal on a half-duplex time-frequency resource according to a second transmission parameter.

18. The device according to claim 17, wherein the instructions further comprise instructions to:
determine a fourth device whose signal-to-interference-plus-noise ratio (SINR) is greater than a preset threshold or whose channel quality indicator (CQI) is greater than a preset channel quality threshold, wherein the fourth device comprises at least one device;
determine a fifth device whose power headroom (PH) is greater than a preset headroom threshold, wherein the fifth device comprises at least one device;
receive, on the full-duplex time-frequency resource, an uplink signal sent by the fifth device; and
send the first downlink signal to the at least one device in the fourth device on the full-duplex time-frequency resource according to the first transmission parameter.

19. The device according to claim 8, wherein the instructions further comprise instructions to:
determine a self-interference compensation amount of the device according to:
Δ_{SI}=10*log₁₀(N+1) dB
wherein Δ_{SI} indicates the self-interference compensation amount, N indicates that self-interference residual power is N multiples of noise power, and N>0.

20. A method, comprising:
determining, by a first device, uplink transmit power; and
sending, by the first device on a first time-frequency resource using the uplink transmit power, an uplink signal to a second device that operates in a full-duplex mode, wherein the uplink transmit power is power determined according to a self-interference compensation amount of the second device, or the uplink transmit power is determined to be the uplink transmit power is maximum transmit power of the first device.
